(19) United States
(12) Patent Application Publication
(10) Pub. No.: US 2013/0302009 A1
(43) Pub. Date: Nov. 14, 2013

(54) INFORMATION PROCESSING APPARATUS, INFORMATION PROCESSING SYSTEM, AND INFORMATION PROCESSING METHOD

(71) Applicant: SONY CORPORATION, Tokyo (JP)

(72) Inventors: AKIHIKO KINOSHITA, Tokyo (JP); NOBORU MURABAYASHI, Saitama (JP)

(73) Assignee: SONY CORPORATION, Tokyo (JP)

(21) Appl. No.: 13/861,631

(22) Filed: Apr. 12, 2013

(30) Foreign Application Priority Data
May 10, 2012 (JP) 2012-108556

(51) Int. Cl. H04N 9/87

(52) U.S. Cl. CPC H04N 9/87
USPC 386/239

(57) ABSTRACT

An information processing apparatus includes an operation information holding unit, an attribution obtaining unit, and an operation information presentation unit. The operation information holding unit is configured to hold operation information for each attribution of content. The attribution obtaining unit is configured to obtain an attribution of reproduction content that is content being reproduced. The operation information presentation unit is configured to present operation information corresponding to the reproduction content based on the attribution.

### BACKGROUND

The present disclosure relates to an information processing apparatus that reproduces content and provides an operation guide to a user, an information processing system, and an information processing method.

An HDD (Hard disk drive) recorder, a BD (Blu-ray Disc (registered trademark)) recorder, and the like, which record and reproduce a TV program, other video content, or the like, are widely used. Such an apparatus has various recording/reproduction functions. Therefore, it is considered that the method of operating the apparatus is difficult to understand in some cases. An electronic operation guide (operation manual), which presents, for such a case, operation information (operation guide) on a predetermined screen for a user who does not understand the operation method, has been known.

For example, WO 2010/023886 discloses an operation support apparatus that estimates an intended function based on a user's operation history, and determines an operation support method. When a user performs a predetermined operation with specific content being selected by the user, the apparatus is capable of estimating the type of the content based on the operation history, and performing operation support, e.g., displaying an operation guide.

### SUMMARY

However, because the apparatus described in WO 2010/023886 performs the estimation based on a user's operation, the apparatus can be applied in a case where the user understands the operation that can be performed on the content, otherwise the apparatus is hard to be applied. Because content is used in various forms in recent years, a wide variety of operations can be performed on content and the operation that can be performed are different depending on the type of content, in most cases. Therefore, it is not expected that the user understands all the operations that can be performed, in some cases.

In view of the circumstances as described above, it is desirable to provide an information processing apparatus that is capable of presenting, to a user, an operation that can be performed on content being reproduced, an information processing system, and an information processing method.

An information processing apparatus according to an embodiment of the present disclosure includes an operation information holding unit, an attribution obtaining unit, and an operation information presentation unit.

The operation information holding unit is configured to hold operation information for each attribution of content.

The attribution obtaining unit is configured to obtain an attribution of reproduction content that is content being reproduced.

The operation information presentation unit is configured to present operation information corresponding to the reproduction content based on the attribution.

With this configuration, operation information (e.g., operation guide) corresponding to the attribution (e.g., genre of the reproduction content) of the reproduction content is presented to a user. Therefore, even if the user does not understand behavior that the information processing apparatus is capable of performing on the reproduction content, it is possible to cause the information processing apparatus to perform the behavior by using the operation information.

The attribution obtaining unit may obtain the attribution based on a feature amount detected from the reproduction content.

With this configuration, the attribution obtaining unit is capable of obtaining the attribution of the reproduction content by using the feature amount of the reproduction content, e.g., a speech power spectrum, and a feature point motion vector. Accordingly, even if the user does not know the genre of the reproduction content, e.g., the reproduction content is movie content distributed by streaming distribution, the user can use the operation information corresponding to the attribution of the reproduction content.

The attribution obtaining unit may obtain the attribution based on meta-information added to the reproduction content.

With this configuration, the attribution obtaining unit is capable of obtaining the attribution of the reproduction content by using meta-information on the reproduction content, e.g., EPG (electronic program guide).

The attribution obtaining unit may obtain the attribution based on information on connection of an external apparatus that supplies the reproduction content to the information processing apparatus.

With this configuration, the attribution obtaining unit is capable of obtaining the attribution of the reproduction content by using the information on connection of the external apparatus to the information processing apparatus, e.g., an HDMI (High-Definition Multimedia Interface) signal. The attribution obtaining unit is capable of determining that the reproduction content is video taken by a personal video camera, by, for example, detecting connection of the personal video camera to the information processing apparatus.

The information processing apparatus may further include an operation history storage unit configured to store an operation history for each attribution of content, and the operation information presentation unit may present the operation information based on, in addition to the attribution, the operation history corresponding to the reproduction content.

With this configuration, because the operation history storage unit stores the user's operation history for each attribution of the content, the operation information presentation unit is capable of presenting the operation information by using, in addition to the attribution of the reproduction content, the operation history corresponding to the content having the attribution. Accordingly, for example, in a case where a user frequently records a certain genre of content, the operation information presentation unit is capable of displaying an operation guide to recording on the reproduction content in the genre.

The operation information presentation unit may determine priorities of the operation information based on the operation history.

With this configuration, in a case where there are a plurality of pieces of operation information corresponding to the reproduction content, the operation information presentation unit is capable of preferentially presenting the operation information according to the priorities based on the operation history. Accordingly, the operation information presentation unit is capable of presenting the operation information on an operation that the user frequently performs.

The operation information may indicate an operation guide to behavior that the information processing apparatus is capable of performing on the reproduction content.

With this configuration, a user can easily understand the behavior that the information processing apparatus is capable of performing on the reproduction content and the method of operating the information processing apparatus.

The operation information may indicate presentation of behavior of the information processing apparatus performed on the reproduction content.

With this configuration, a user can select desired behavior out of the behavior that the information processing apparatus is capable of performing on the reproduction content, and cause the information processing apparatus to perform the desired behavior.

The reproduction content may be movie content, and the meta-information may be added to a scene in the reproduction content.

With this configuration, the attribution obtaining unit is capable of obtaining the attribution for each scene. Accordingly, it is possible to record only a singing scene in music program content, or to skip a CM section, for example.

The information processing apparatus may be configured to be capable of recording and reproducing content.

An information processing system according to an embodiment of the present disclosure includes an operation information holding unit, an attribution obtaining unit, and an operation information presentation unit.

The operation information holding unit is configured to hold operation information for each attribution of content.

The attribution obtaining unit is configured to obtain an attribution of reproduction content that is content being reproduced.

The operation information presentation unit is configured to present operation information corresponding to the reproduction content based on the attribution.

An information processing method according to an embodiment of the present disclosure includes

holding operation information for each attribution of content by an operation information holding unit;

obtaining an attribution of reproduction content that is content being reproduced an attribution obtaining unit; and

presenting operation information corresponding to the reproduction content based on the attribution an operation information presentation unit.

As described above, according to the present disclosure, it is possible to provide an information processing apparatus that is capable of presenting, to a user, an operation that can be performed on content being reproduced, an information processing system, and an information processing method.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a configuration of an information processing apparatus according to an embodiment of the present disclosure;

FIG. 2 is a schematic diagram showing a functional configuration of the information processing apparatus;

FIG. 3 shows an example of operation information presented by the information processing apparatus;

FIG. 4 is a flowchart showing behavior of the information processing apparatus;

FIG. 5 is a schematic diagram showing an example of a user's desired operation on reproduction content;

FIG. 6 is another schematic diagram showing an example of a user's desired operation on reproduction content;

FIG. 7 is a table showing examples of the attribution of content in a reproduction mode and presented operation information;

FIG. 8 is another table showing examples of the attribution of content in a reproduction mode and presented operation information;

FIG. 9 is a flowchart showing the obtaining of the attribution by the information processing apparatus in detail;

FIG. 10 is a schematic diagram showing the feature amount extraction processing performed by the information processing apparatus;

FIG. 11 is a table showing examples of the attribution of content in a recording mode and presented operation information;

FIG. 12 is a table showing examples of the attribution of content in a recording mode and presented operation information; and

FIG. 13 is a schematic diagram showing a configuration of an information processing system according to an embodiment of the present disclosure.

### DETAILED DESCRIPTION OF EMBODIMENTS

[Configuration of Information Processing Apparatus]

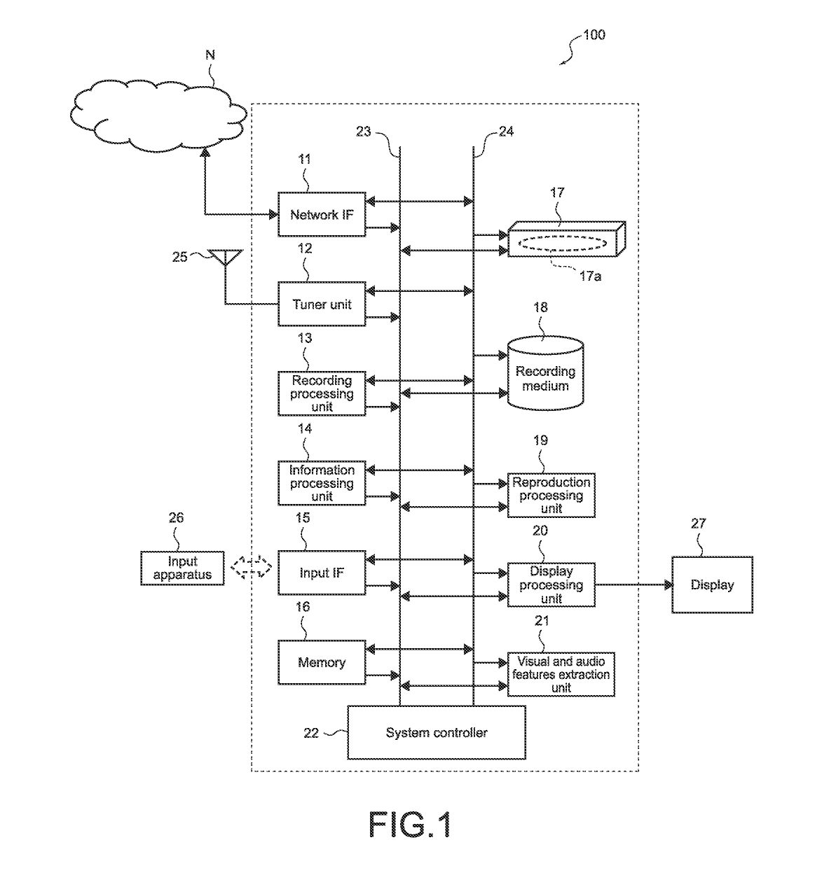

An information processing apparatus according to an embodiment of the present disclosure will be described. FIG. 1 is a block diagram showing a configuration of an information processing apparatus 100. The information processing apparatus 100 may be a recording/reproduction apparatus (e.g., HDD (Hard disk drive) recorder and BD (Blu-ray Disc (registered trademark)) recorder) that is capable of recording and reproducing movie content, but it is not limited thereto.

As shown in FIG. 1, the information processing apparatus 100 includes a network IF (interface) 11, a tuner unit 12, a recording processing unit 13, an information processing unit 14, an input IF 15, a memory 16, a disc drive 17, a recording medium 18, a reproduction processing unit 19, a display processing unit 20, a visual and audio features extraction unit 21, a system controller 22, a data bus 23, and a control bus 24.

The network IF 11, the tuner unit 12, the recording processing unit 13, the information processing unit 14, the input IF 15, the memory 16, the disc drive 17, the recording medium 18, the reproduction processing unit 19, the display processing unit 20, the visual and audio features extraction unit 21, and the system controller 22 are connected to the data bus 23 and the control bus 24. The network IF 11 is connected to a network (e.g., the Internet) N, and an antenna 25 is connected to the tuner unit 12. To the input IF 15, an input apparatus (e.g., keyboard and mouse) 26 is connected, and to the display processing unit 20, a display 27 is connected.

The network IF 11 communicates with the network N. The tuner unit 12 receives broadcast waves via the antenna 25, and generates a video signal. The recording processing unit 13 performs recording processing on the video signal generated by the tuner unit 12. The information processing unit 14 performs processing such as estimating of the attribution of content, which will be described later. The input IF 15 receives an input signal generated in the input apparatus 26 in response to a user's operation.

For example, a program processed in the information processing unit 14 is written to or retrieved from the memory 16. The disc drive 17 retrieves information stored in a disc-shaped recording medium 17a, e.g., content, or stores information in the disc-shaped recording medium 17a. The recording medium 18 stores a program and content. The reproduction processing unit 19 performs reproduction processing on content stored in the disc drive 17 or the recording medium 18.

The display processing unit 20 generates a video signal from content being reproduced by the reproduction processing unit 19, and supplies the video signal to the display 27. The visual and audio features extraction unit 21 extracts a visual feature amount and/or an audio feature amount (which will be described later) of content being reproduced by the reproduction processing unit 19, and supplies the feature amount to the information processing unit 14. The system controller 22 controls transmission and reception of various signals performed between the respective units via the data bus 23 and the control bus 24.

The information processing apparatus 100 may have the configuration described above. It should be noted that the configuration of the information processing apparatus 100 is not limited to that shown here, and can be changed as appropriate. It is also considered that the information processing apparatus 100 has the following functional configuration by the cooperation between the hardware configuration described above and software loaded onto the hardware.

[Functional Configuration of Information Processing Apparatus]

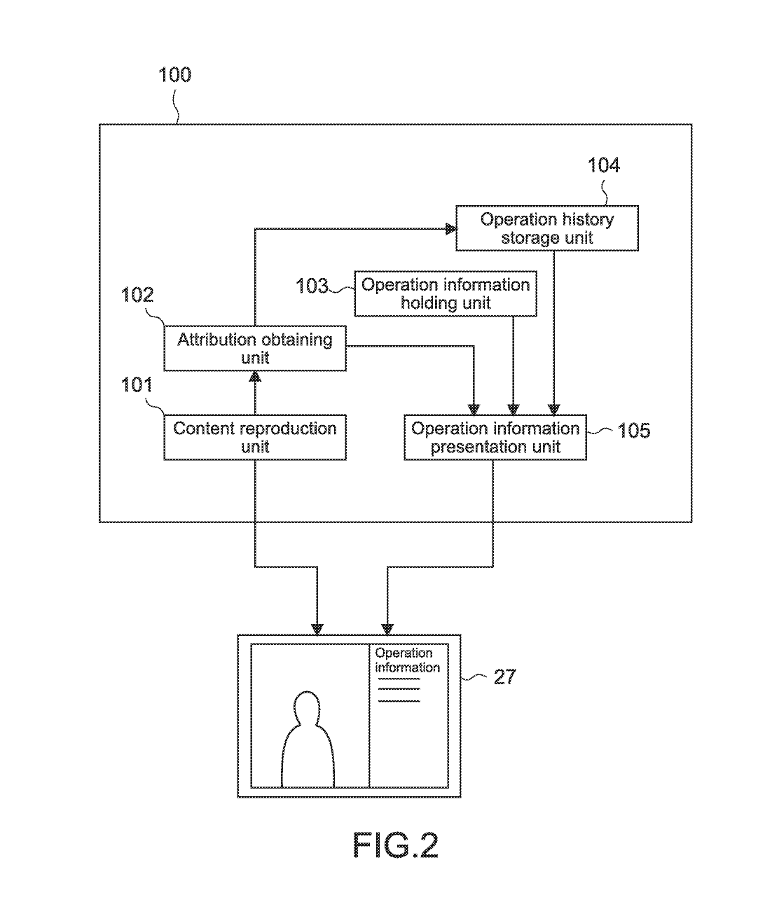

FIG. 2 shows an example of a block diagram showing a functional configuration of the information processing apparatus 100. As shown in FIG. 2, the information processing apparatus 100 includes, as a functional configuration, a content reproduction unit 101, an attribution obtaining unit 102, an operation information holding unit 103, an operation history storage unit 104, and an operation information presentation unit 105. It should be noted that the content reproduction unit 101 may be incorporated into another apparatus that is different from the information processing apparatus 100, e.g., a television receiver.

The content reproduction unit 101 obtains recorded content or content to be broadcasted or distributed, and reproduces the content. Hereinafter, content being reproduced by the content reproduction unit 101 is referred to as reproduction content. It should be noted that the reproduction content is not limited to movie content, and may be audio content or still image content.

Moreover, in a case where the content is movie content, the reproduction content may be a scene (e.g., singing scene) in the content, or a frame (still image) in the content. The attribution obtaining unit 102 obtains the “attribution” of the reproduction content being reproduced by the content reproduction unit 101. The attribution includes a genre of content. For example, in a case where the content is movie content, the genre includes music program content, news program content, and drama program content. Moreover, the attribution includes a generation means for content such as whether or not the content is taken by a personal video camera. Furthermore, the attribution includes also the attribution of a scene in movie content such as a boundary between a CM (commercial message) section and a non-CM section.

The attribution obtaining unit 102 may obtain the attribution of the reproduction content by using meta-information on the reproduction content (e.g., EPG (electronic program guide)). Moreover, the attribution obtaining unit 102 may obtain the attribution of the reproduction content by using the feature amount of the reproduction content, (e.g., speech power spectrum and feature point motion vector). Furthermore, the attribution obtaining unit 102 may obtain the attribution of the reproduction content by using information on connection of an external apparatus (e.g., HDMI (High-Definition Multimedia Interface) signal) that is connected to the information processing apparatus 100 and supplies the reproduction content to the information processing apparatus 100. The attribution obtaining unit 102 supplies the obtained attribution of the reproduction content (hereinafter referred to as reproduction content attribution) to the operation information presentation unit 105.

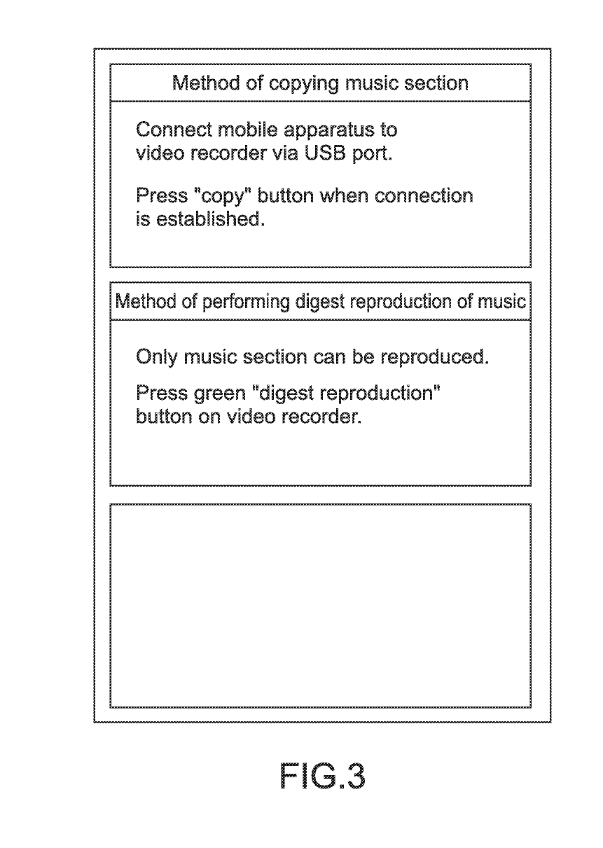

The operation information holding unit 103 holds operation information for each attribution of content. The operation information is information that is assumed to be necessary for a user with respect to each piece of content, such as an operation guide (manual) and presentation of behavior that the information processing apparatus 100 is capable of performing. The operation information holding unit 103 associates the attribution of each piece of content with the operation information on the content and holds them (maintains them in an available state). The operation information holding unit 103 may hold operation information recorded in the recording medium 18 or the like, and may hold operation information in the network N. FIG. 3 shows an operation guide as an example of operation information. The operation history storage unit 104 stores a user's operation history with respect to each piece of content. Specifically, the operation history storage unit 107 may obtain the reproduction content attribution from the attribution obtaining unit 102, and store the frequency of a user's operation with respect to the reproduction content. The operation history indicates, for example, how many times the recording operation is performed and how many times the digest reproduction is performed in a case where the reproduction content is music program content. In other words, the operation history includes the user's operation tendency with respect to each piece of content.

The operation information presentation unit 105 presents the operation information corresponding to the reproduction content being reproduced by the content reproduction unit 101. The operation information presentation unit 105 obtains, from the operation information holding unit 103, the operation information corresponding to the attribution of the reproduction content obtained by the attribution obtaining unit 102.

Moreover, the operation information presentation unit 105 may give a predetermined priority to each piece of operation information in a case where the operation information includes a plurality of pieces of operation information. At this time, the operation information presentation unit 105 may also give a priority by using the operation history of content belonging to the same attribution as that of the reproduction content, out of the operation history stored in the operation history storage unit 104.

The operation information presentation unit 105 may supply operation information or operation information given a priority to an output means (e.g., display 27) to present the operation information. The operation information presentation unit 105 may present the operation information by using the same output means as that outputs the reproduction content (e.g., display 27), or may present the operation information by using a different output means from that outputs the reproduction content (e.g., smartphone).

[Behavior of Information Processing Apparatus]

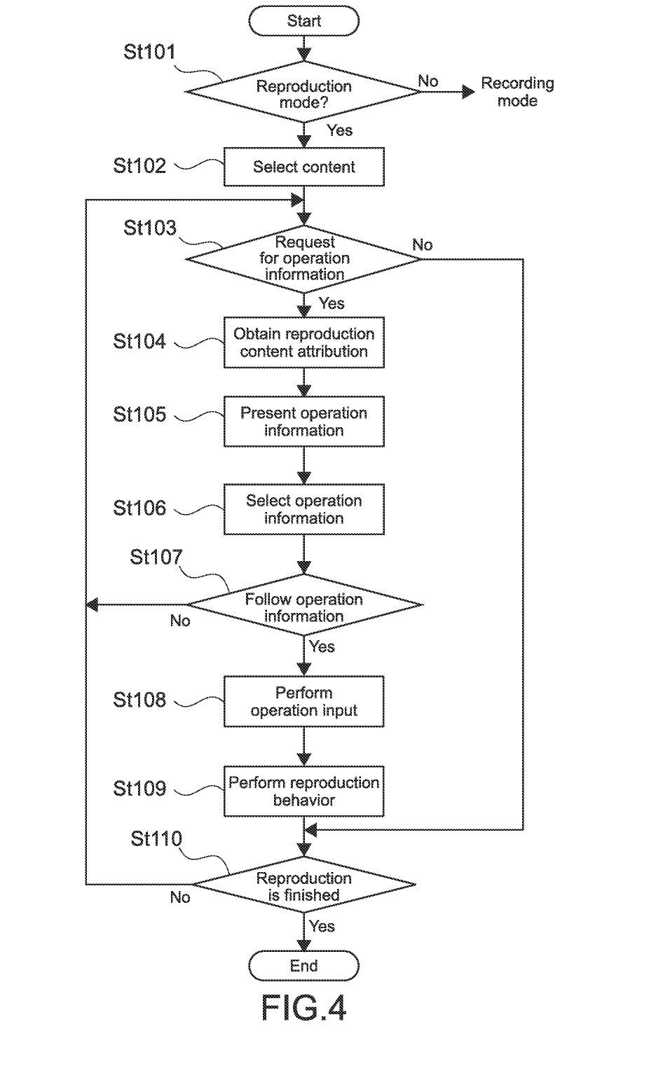

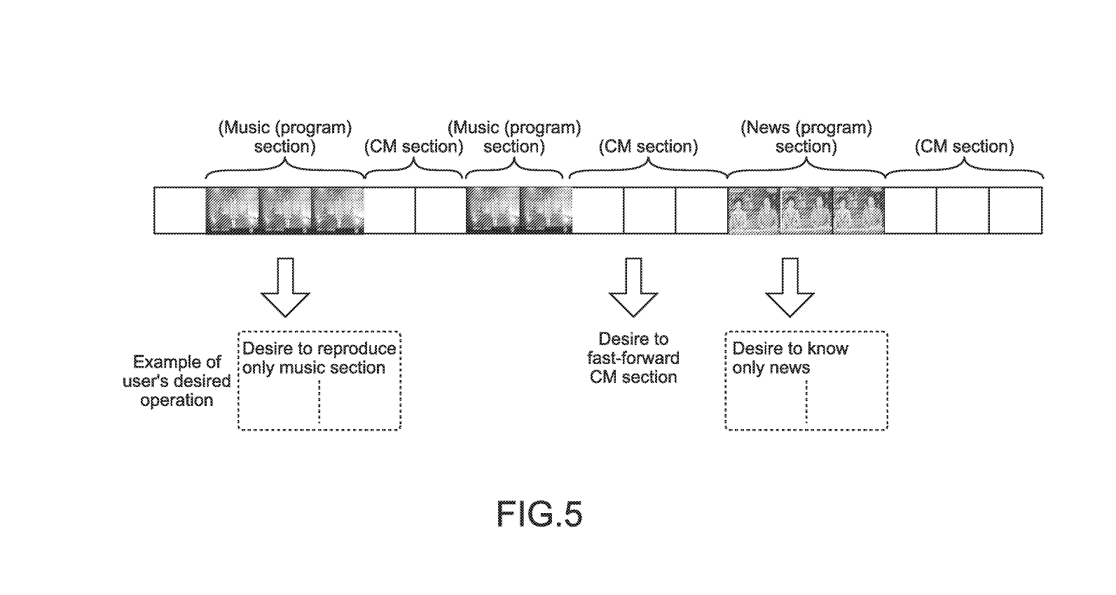

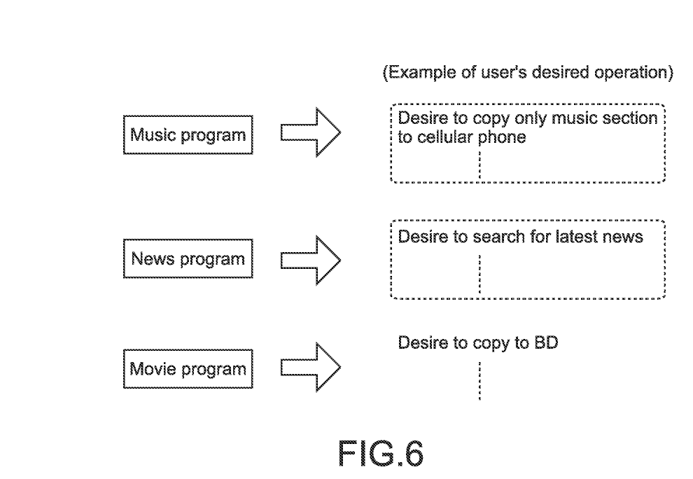

FIG. 4 is a flowchart showing behavior of the information processing apparatus 100. FIG. 5 and FIG. 6 are each a schematic diagram showing an example of a user's desired operation on the reproduction content. FIG. 5 shows an example of a user's desired operation in a case where the reproduction content is a video stream and the user does not know the attribution of the content (content genre). As shown in FIG. 5, it is considered that the user desires to view and listen to only the music program section in a music program and fast-forward the CM section in some cases. Moreover, it is considered that the user desires to know only news in a news program in some cases.

FIG. 6 shows an example of a user's desired operation in a case where the user knows the attribution of the content (content genre) in advance. As shown in FIG. 6, it is considered that the user desires to copy the music section in a music program to a cellular phone, search for latest news in a news program, and copy a movie program to a BD, for example.

As shown in FIG. 4, whether the current mode is a reproduction mode or a recording mode is confirmed by the information processing apparatus 100 (St101). In a case where the current mode is not the reproduction mode (St101: No), the information processing apparatus 100 shifts to the recording mode.

In a case where the information processing apparatus 100 is in the reproduction mode (St101: Yes), content to be reproduced is selected by the user (St102). Next, whether or not there is a request for operation information (e.g., display request for an operation guide) is confirmed (St103). The information processing apparatus 100 is capable of determining whether or not there is a request for operation information based on whether or not the user performs an operation input indicating a request for operation information.

Next, the attribution obtaining unit 102 obtains the attribution (reproduction content attribution) of content (reproduction content) being reproduced by the content reproduction unit 101 (St104). The obtaining of the reproduction content attribution will be described later.

Next, the operation information presentation unit 105 presents operation information depending on the attribution of the reproduction content (St105). Specifically, the operation information presentation unit 105 selects, from the operation information held in the operation information holding unit 103, operation information corresponding to the attribution of the reproduction content supplied from the attribution obtaining unit 102, and supplies the operation information to the display 27 or the like to present it to the user.

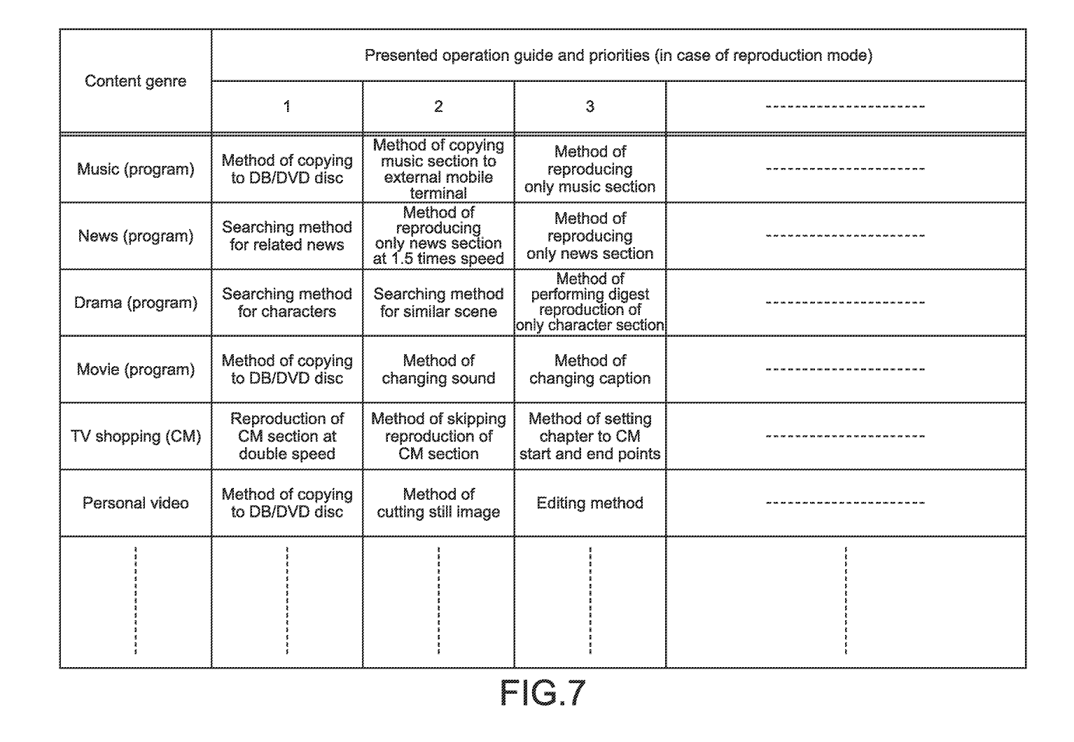

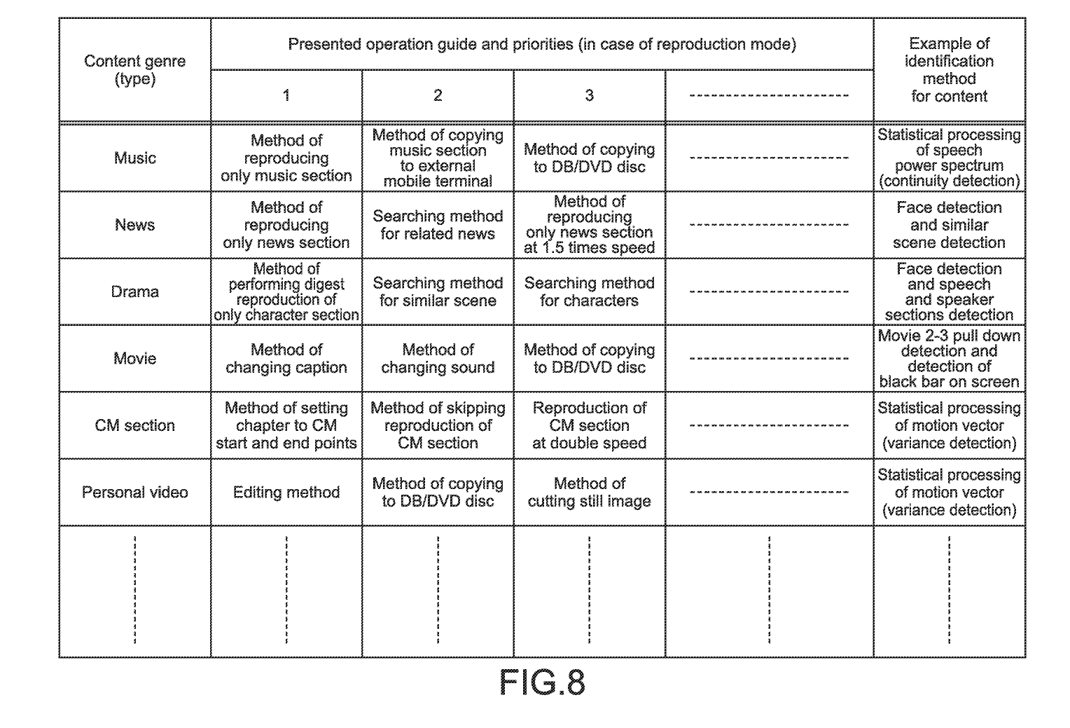

FIG. 7 and FIG. 8 are each a table showing examples of the attribution of content and presented operation information. FIG. 7 shows operation information presented based on the reproduction content attribution that is obtained from meta-information (which will be described later) added to the reproduction content. FIG. 8 shows operation information presented based on the reproduction content attribution that is obtained from the feature amount (which will be described later) detected from the reproduction content. As shown in FIG. 7 and FIG. 8, the operation information may indicate an operation guide to behavior that the information processing apparatus 100 is capable of performing depending on the reproduction content. Accordingly, the user can understand what operation can be performed on the reproduction content, and the operation method. It is also considered that presentation suitable for the user may be made by changing the presented operation information or the order of presented items depending on the source of information on the obtained reproduction content attribution, as described above.

Moreover, the operation information may indicate presentation of behavior of the information processing apparatus 100 performed on the reproduction content. The operation information presentation unit 105 presents a behavior candidate corresponding to the reproduction content of the information processing apparatus 100, and the user selects arbitrary behavior, which allows the information processing apparatus 100 to perform the behavior. For example, in a case where a singing scene in a music program is reproduced, the copy behavior to a mobile apparatus or the reproduction behavior of only a singing scene may be presented.

Moreover, the operation information may be information obtained from the reproduction content. For example, in a case where the reproduction content is a mail order program, the operation information may indicate the telephone number shown in the program. A user can directly call the telephone number.

As shown in FIG. 7 and FIG. 8, the operation information presentation unit 105 may present operation information that is assumed to be necessary for a user depending on the attribution of each piece of content according to the predetermined priorities. The operation information presentation unit 105 may determine priorities of the operation information with reference to a user's operation history with respect to content having the same attribution as that of the reproduction content, which is stored in the operation history storage unit 104.

For example, in a case where a user frequently copies music content to a disc medium when the music content is reproduced, the operation history of the copy operation of music content to a disc medium is frequently stored in the operation history storage unit 104. In a case where the reproduction content is music content, the operation information presentation unit 105 may give a high priority to the operation information indicating the procedure of the copy operation to a disc medium, based on the operation history.

The user selects desired operation information from the presented operation information (St106), and performs a predetermined operation input (St108) in accordance with the operation information (St107: Yes). If the user does not follow the operation information (St107: No), the process returns to a step of confirming whether or not there is a request for operation information (St103). The information processing apparatus 100 performs the behavior designated by a user's operation input, e.g., copying of the reproduction content to a disc medium (St109), and terminates the behavior when the reproduction of the reproduction content is finished (St110: Yes). If the reproduction of the reproduction content is not finished (St110: No), the process returns to a step of confirming whether or not there is a request for operation information (St103).

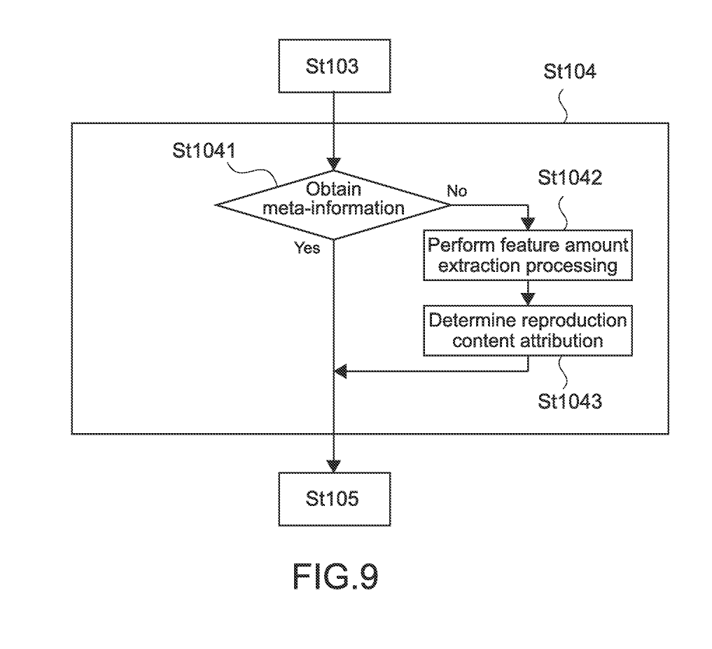

The obtaining of the attribution by the attribution obtaining unit 102 (St104) will be described in detail. FIG. 9 is a flowchart showing the obtaining of the attribution in detail.

The attribution obtaining unit 102 confirms whether or not meta-information (e.g., EPG) of the reproduction content can be obtained (St1041). In a case where meta-information of the reproduction content can be obtained (St1041: Yes), the attribution obtaining unit 102 may obtain the attribution of the reproduction content from the meta-information. Moreover, in a case where the reproduction content is movie content, and meta-information is added to each scene or frame in the reproduction content, the attribution obtaining unit 102 may obtain the attribution of the reproduction content from the meta-information for each scene or frame.

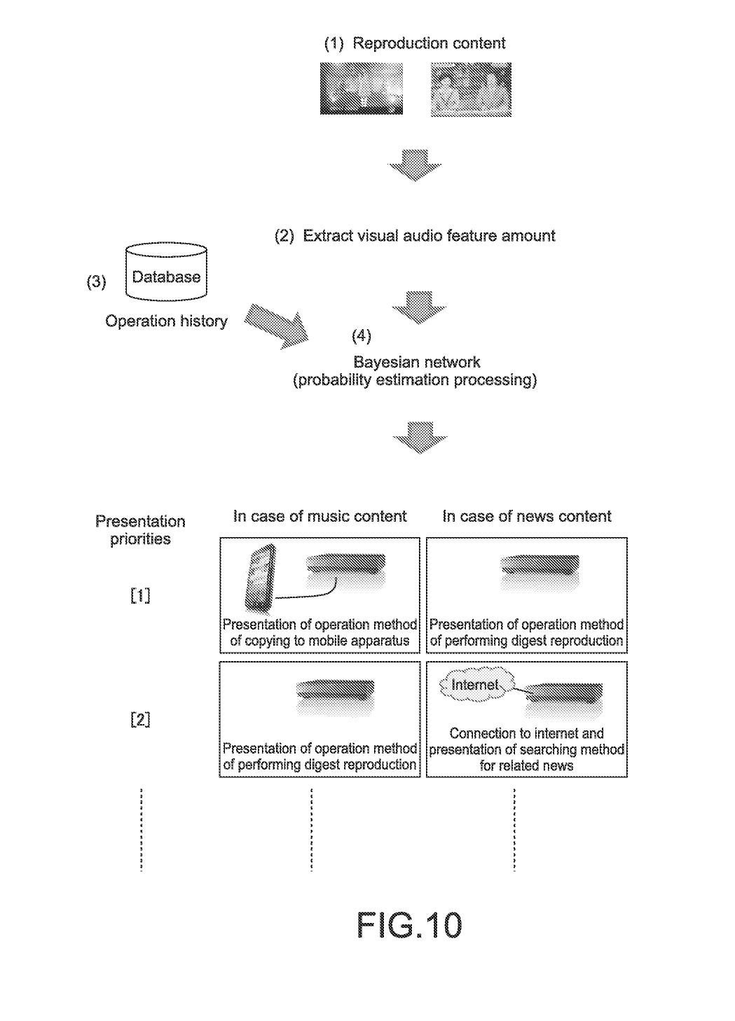

In a case where meta-information of the reproduction content is not obtained (St1041: No), the attribution obtaining unit 102 performs feature amount extraction processing on the reproduction content (St1042). FIG. 10 is a schematic diagram showing the feature amount extraction processing. As shown in FIG. 10, the attribution obtaining unit 102 extracts a feature amount (2) from the reproduction content (1). The feature amount includes, for example, extraction of a speech power spectrum, face recognition processing, and detection of a feature point motion vector. The attribution obtaining unit 102 may perform probability estimation (stochastic reasoning) processing based on a Bayesian network (4) on a feature amount extracted in (2) described above, as well as information related to a user's operation history (including information on an operation mode such as search, normal reproduction, fast-forward, and rewind, and a visual audio feature amount of content at that time) (3), which is stored in the operation history storage unit 104 (database), and determine the attribution of the reproduction content.

Specifically, the attribution obtaining unit 102 is capable of obtaining excitement of a scene, interval of a scene change, or the like from the camera work or speech power spectrum of content that can be obtained from a feature point motion vector to obtain the attribution such as whether the scene is a singing scene or a CM section. Such obtaining of the attribution (estimation of the type of a scene) can be achieved by a known method (e.g., Japanese Patent Application Laid-open No. 2006-054620).

The technique using a Bayesian network is disclosed in, for example, the following document: Yoichi Motomura, “Bayesian networks”, Technical Report of IEICE (the Institute of Electronics, Information and Communication Engineers), NO. NC2003-38, pp. 25-30, 2003.

In the technique, the most probable event is inferred based on several predetermined random variables.

The event with respect to each random variable is stored in a table.

In (4) described above, a visual audio feature amount of several pieces of content whose attributions are known stored in a database in advance, a visual audio feature amount of the reproduction content whose attribution is expected to be estimated, information on the operation history with respect to the content whose attribution is known, operation information on the reproduction content, and the like are used as random variables, and processing is performed with the attribution to be estimated as an event.

Specifically, the ratio between values of various visual audio feature amounts of content whose attribution is known and various corresponding visual audio feature amounts of the reproduction content is used as a random variable to calculate the sum value. Moreover, the random variable of the sum value is weighted by a coefficient. The coefficient differs depending on each random variable described above, and is, for example, 1 in a case of the same operation mode, and 0.5 in a case of a different operation mode. The operation information on an operation mode such as search and normal reproduction is finally used as a random variable.

Then, based on the random variable thus calculated, the attribution of the reproduction content is one that is most probable to be the same as that of content whose attribution is known. Here, in addition to the probability estimation processing based on a Bayesian network described above, a machine learning method such as a neural network and SVM (support vector machine) is considered to be used. In this case, learning processing is performed by using information on a user's operation history stored in a database and a visual audio feature amount at that time stored therewith, a feature amount from the reproduction content (1) is input, and determination processing based on machine learning is performed on the attribution of the reproduction content.

Moreover, the attribution obtaining unit 102 is capable of obtaining information on the attribution of the reproduction content by using information on connection of an external apparatus to the information processing apparatus 100. For example, in a case where a personal video camera is connected to the information processing apparatus 100, the attribution obtaining unit 102 is capable of detecting connection of the personal camera based on the information on connection thereof (e.g., HDMI signal), and determining that the reproduction content is supplied from the personal video camera.

As described above, the information processing apparatus 100 is capable of presenting, to a user, operation information corresponding to the reproduction content being reproduced by the content reproduction unit 101. Accordingly, the user can refer to information on the operation that can be performed on the content being reproduced. Therefore, the user does not need to understand what operation can be performed on the content.

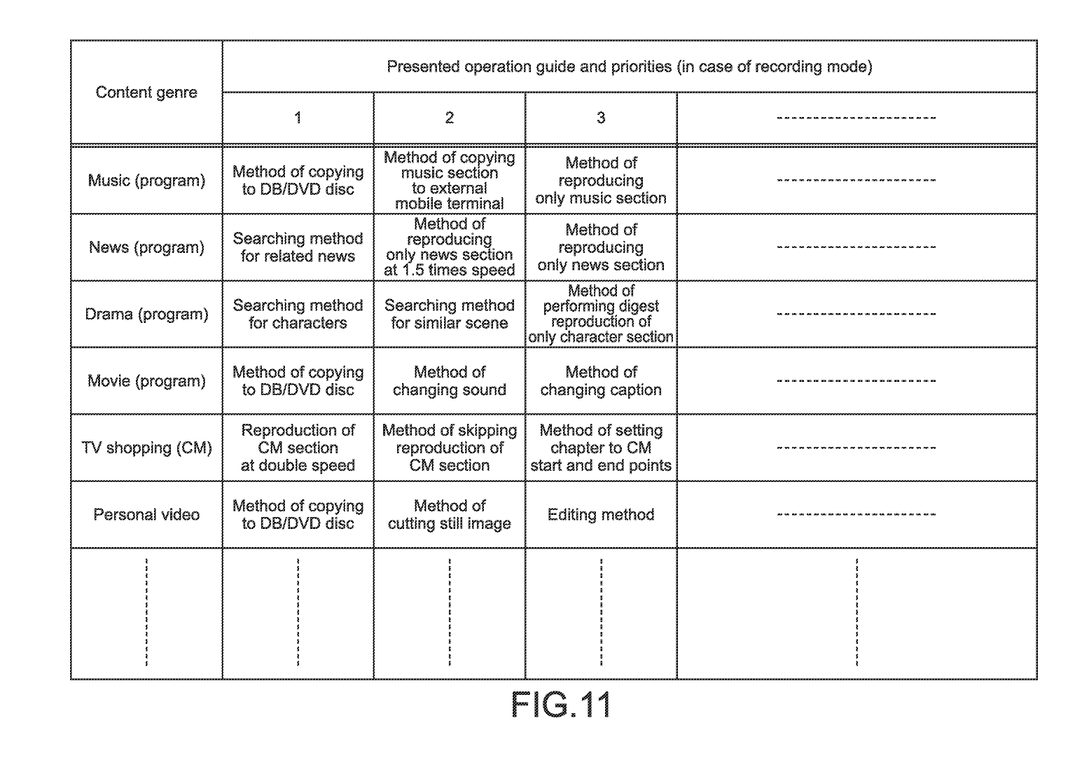

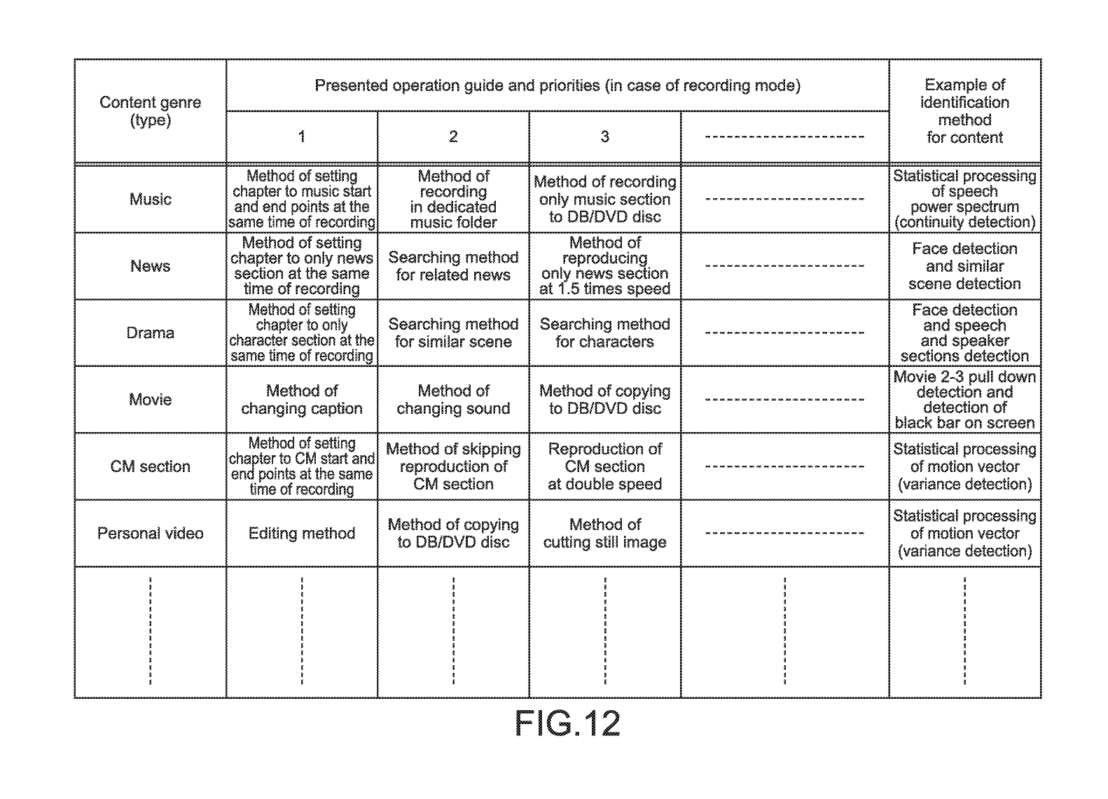

In the description above, the information processing apparatus 100 is in the reproduction mode, but the same shall apply to a case where the information processing apparatus 100 is in the recording mode. Specifically, the attribution obtaining unit 102 obtains the attribution of the reproduction content being reproduced by the content reproduction unit 101 (e.g., that incorporated into a television receiver) in the above-mentioned manner, and the operation information presentation unit 105 presents operation information depending on the attribution of the reproduction content. FIG. 11 and FIG. 12 are each a table showing an example of the attribution of content and presented operation information. FIG. 11 shows operation information presented based on the reproduction content attribution that is obtained from meta-information added to the reproduction content. FIG. 12 shows operation information presented based on the reproduction content attribution that is obtained by using a feature amount detected from the reproduction content. As in the case of FIG. 7 and FIG. 8, it is considered that presentation suitable for the user may be made by changing the presented operation information or the order of presented items depending on the source of information on the reproduction content attribution.

The present disclosure is not limited to the above-mentioned embodiments and modifications can be made without departing from the gist of the present disclosure.

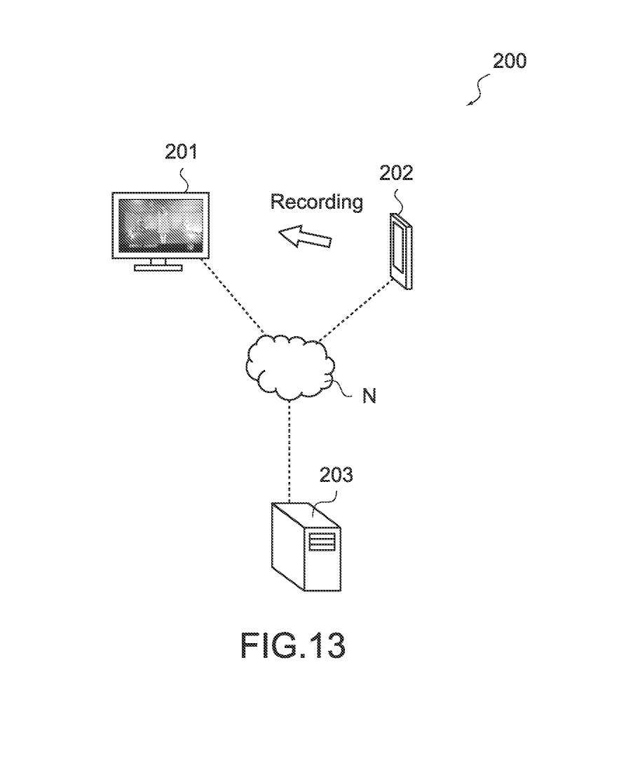

In the embodiments described above, the information processing apparatus 100 is a recording/reproduction apparatus, but it is not limited thereto. The present disclosure can be applied to an information processing system including a plurality of apparatuses. FIG. 13 is a schematic diagram showing an information processing system 200. As shown in FIG. 13, the information processing system 200 includes a content reproduction apparatus 201, a mobile apparatus 202, and a server 203.

The content reproduction apparatus 201 is, for example, a television receiver having a recording/reproduction function, and may include a content reproduction unit, an operation information holding unit, and an operation history storage unit. The mobile apparatus 202 is, for example, a smartphone, and may include an operation information presentation unit, a camera, a microphone, and the like. The server 203 may include an attribution obtaining unit. The content reproduction apparatus 201, the mobile apparatus 202, and the server 203 are connected to each other via the network N. In the information processing system, the mobile apparatus 202 takes an image of content (reproduction content), which is being reproduced by the content reproduction apparatus 201, with a camera and a microphone. The recorded image and sound of the reproduction content are transmitted to the server 203 via the network N, the server 203 performs feature amount extraction processing and probability estimation processing thereon, and the reproduction content attribution is detected. The reproduction content attribution may be supplied to the mobile apparatus 202, and the mobile apparatus 202 may present operation information corresponding to the reproduction content attribution.

It should be noted that the present disclosure may also take the following configurations.

(1) An information processing apparatus, including:

an operation information holding unit configured to hold operation information for each attribution of content;

an attribution obtaining unit configured to obtain an attribution of reproduction content that is content being reproduced; and an operation information presentation unit configured to present operation information corresponding to the reproduction content based on the attribution.

(2) The information processing apparatus according to (1), in which

the attribution obtaining unit is configured to obtain the attribution based on a feature amount detected from the reproduction content.

(3) The information processing apparatus according to (1) or (2), in which

the attribution obtaining unit is configured to obtain the attribution based on meta-information added to the reproduction content.

(4) The information processing apparatus according to any one of (1) to (3), in which

the attribution obtaining unit is configured to obtain the attribution based on information on connection of an external apparatus that supplies the reproduction content to the information processing apparatus.

(5) The information processing apparatus according to any one of (1) to (4), further including

an operation history storage unit configured to store an operation history for each attribution of content, in which

the operation information presentation unit is configured to present the operation information based on, in addition to the attribution, the operation history corresponding to the reproduction content.

(6) The information processing apparatus according to any one of (1) to (5), in which

the operation information presentation unit is configured to determine priorities of the operation information based on the operation history.

(7) The information processing apparatus according to any one of (1) to (6), in which

the operation information indicates an operation guide to behavior that the information processing apparatus is capable of performing on the reproduction content.

(8) The information processing apparatus according to any one of (1) to (7), in which

the operation information indicates presentation of behavior of the information processing apparatus performed on the reproduction content.

(9) The information processing apparatus according to any one of (1) to (8), in which

the reproduction content is movie content, and the meta-information is added to a scene in the reproduction content.

(10) The information processing apparatus according to any one of (1) to (9), in which

the information processing apparatus is configured to be capable of recording and reproducing content.

(11) An information processing system, including:

an operation information holding unit configured to hold operation information for each attribution of content;

an attribution obtaining unit configured to obtain an attribution of reproduction content that is content being reproduced; and

an operation information presentation unit configured to present operation information corresponding to the reproduction content based on the attribution.

(12) An information processing method, including:

holding operation information for each attribution of content by an operation information holding unit;

obtaining an attribution of reproduction content that is content being reproduced an attribution obtaining unit; and

presenting operation information corresponding to the reproduction content based on the attribution an operation information presentation unit.

The present disclosure contains subject matter related to that disclosed in Japanese Priority Patent Application JP 2012-108556 filed in the Japan Patent Office on May 10, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
an operation information holding unit configured to hold operation information for each attribution of content;
an attribution obtaining unit configured to obtain an attribution of reproduction content that is content being reproduced; and
an operation information presentation unit configured to present operation information corresponding to the reproduction content based on the attribution.

2. The information processing apparatus according to claim 1, wherein
the attribution obtaining unit is configured to obtain the attribution based on a feature amount detected from the reproduction content.

3. The information processing apparatus according to claim 1, wherein
the attribution obtaining unit is configured to obtain the attribution based on meta-information added to the reproduction content.

4. The information processing apparatus according to claim 1, wherein
the attribution obtaining unit is configured to obtain the attribution based on information on connection of an external apparatus that supplies the reproduction content to the information processing apparatus.

5. The information processing apparatus according to claim 1, further comprising
an operation history storage unit configured to store an operation history for each attribution of content, wherein
the operation information presentation unit is configured to present the operation information based on, in addition to the attribution, the operation history corresponding to the reproduction content.

6. The information processing apparatus according to claim 1, wherein
the operation information presentation unit is configured to determine priorities of the operation information based on the operation history.

7. The information processing apparatus according to claim 1, wherein
the operation information indicates an operation guide to behavior that the information processing apparatus is capable of performing on the reproduction content.

8. The information processing apparatus according to claim 1, wherein
the operation information indicates presentation of behavior of the information processing apparatus performed on the reproduction content.

9. The information processing apparatus according to claim 3, wherein
the reproduction content is movie content, and the meta-information is added to a scene in the reproduction content.

10. The information processing apparatus according to claim 1, wherein
the information processing apparatus is configured to be capable of recording and reproducing content.

11. An information processing system, comprising:
an operation information holding unit configured to hold operation information for each attribution of content;
an attribution obtaining unit configured to obtain an attribution of reproduction content that is content being reproduced; and
an operation information presentation unit configured to present operation information corresponding to the reproduction content based on the attribution.

12. An information processing method, comprising:
holding operation information for each attribution of content by an operation information holding unit;
obtaining an attribution of reproduction content that is content being reproduced an attribution obtaining unit; and
presenting operation information corresponding to the reproduction content based on the attribution an operation information presentation unit.
